(19) United States
(12) Patent Application Publication
(10) Pub. No.: US 2007/0067384 A1
(43) Pub. Date: Mar. 22, 2007

(54) System and method for web services configuration creation and validation

(76) Inventor: Dimitar V. Angelov, Montana (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,203

(22) Filed: Sep. 21, 2005

(51) Int. Cl. G06F 15/16

(52) U.S. Cl. 709/203

(57) ABSTRACT

A system and method for Web services configuration file creation and validation is described. In one embodiment, assertion elements from particular level of a Web services description file are converted into properties. From these properties a configuration file is created.

### BACKGROUND

1. Field of the Invention

This invention relates generally to the field of data processing systems. More particularly, the invention relates to a system and method for improving Web services description generation and maintenance including the formation of WSDL files.

2. Description of the Related Art

The term “web services” can be viewed as a technology for engaging in business relationships (e.g., buying and selling) in a partially or wholly automated fashion over a network such as the Internet. FIG. 1 shows a web services model 100 that includes a registry 101, a service provider 102 and a service consumer 103. A service consumer 103, or “service requestor”, is generally understood to be an entity that seeks and (in cases where a suitable web service is found) uses a particular web service through a network 104.

The registry 101 includes listings of various “available” services, and, may assist the service consumer 103 in searching for a suitable service provider based on the web servicing needs of the service consumer 103. A service provider 102 is the provider of one or more web services that can be accessed over the network 104. Because of the vast expanse of the Internet and interest in automated business engagements, many registries, service consumers and service providers may be in operation at any instant of time.

Presently, the responsibilities of the most prevalent registry function 101 that is associated with the web services effort are defined in various Universal Discovery, Description and Integration (UDDI) specifications provided by uddi.org. Besides providing listings of available services, a UDDI registry 101 may also make available to a service consumer 103 additional details that pertain to any particular web service such as: 1) the location of the web service (e.g., its URI specified by a specific network destination address or name); 2) the capabilities of the web service (e.g., specific methods that are supported by the web service and that may be called upon by the service consumer), and, 3) communication semantics needed for invoking the web service through the network 104 (e.g., the structure of a messaging format and/or protocol needed to properly communicate with the web service).

According to one widely adopted approach, such “additional details” are described in Web Services Definition Language (WSDL) text documents written in eXtensible Markup Language (XML). Here, for example, for each web service that the registry 101 maintains a listing of, the registry 101 also maintains a WSDL document that describes the location, capabilities and communication semantics of the web service. Presently, a WSDL document for a particular web service is expected to include an “abstract interface” description of the web service (which includes the web service's methods and the data passed between the web service provider and web service consumer) and a “concrete implementation” description of the web service (which includes specific protocol and data format specifications for communicating with the web service (referred to as a “binding”) and the location of the web service (referred to as a “port”)).

According to another widely adopted approach, with respect to the actual communication that occurs between the service consumer 103 and the service provider 102, such communication is implemented through an exchange of Simple Object Access Protocol (SOAP) text messages written in XML.

WSDL files are created in the XML format that describe a Web service provider's services as a set of endpoints (or ports) operating on messages containing either document-oriented or procedure-oriented information. For example, a SOAP message may be directed toward a particular port of a Web services provider from a remote client. FIG. 2 illustrates an exemplary WSDL file.

A WSDL file generally contains information for types 201, messages 203, port types 205, bindings 207, and services 209 supported by the Web service provider. From this WSDL file a client may determine how to communicate with a Web service and what functionality the Web service provides.

A type describes for data type definitions using a type system. For example, the type system may be XSD (XML Schema Descriptor). In the example of FIG. 2, the type 201 is an XSD file called patents.xsd. This file is located on the Web service provider's server (here bstz.com).

Messages in a WSDL file are described abstractly and define the data being communicated between endpoints or ports. For example, the message 203 is called “GetStatus” and provides the patent status in the body of the message.

Port types are abstract collections of operations supported by a Web service. Each operation describes a function supported. The port type 205 illustrated describes the operation “GetStatus” including the input and output message format to be adhered to.

Bindings are concrete protocols and define the particular data format for a particular port type. In the example, the binding 207 associates the “GetStatus” operation with a SOAP message.

A port is defined by binding a network protocol and message format. A collection of these ports define a service. The service 209 ties the “PatentAppSoaPBinding to the port “PatentAppPort.”

Current WSDL document generation requires manual intervention to describe the Web service. Either a program such as GLUE is run or the WSDL file is generated manually. In either case, these WSDL files cannot be automatically generated based upon a request to the service provider.

Additionally, WSDL files were generated from web service artifacts such as Virtual Interface, WSD and web-services-deployment-descriptor which were inside a web service archive. The WSDL generation was done at the deployment time of a web service. Accordingly, when request is made for WSDL visualization, the WSDL simply read from the file system. In this approach it is impossible for a configuration to be edited/removed/added at runtime without editing the web service artifacts, updating the archive, and redeploying it.

### SUMMARY

A system and method for Web services configuration file creation and validation is described. In one embodiment, assertion elements from particular level of a Web services description file are converted into properties. From these properties a configuration file is created.

### FIGURES

The present invention is illustrated by way of example, and not limitation, in the figures of the accompanying drawings in which like references indicate similar elements and in which:

FIG. 1 shows a Web services model (prior art);

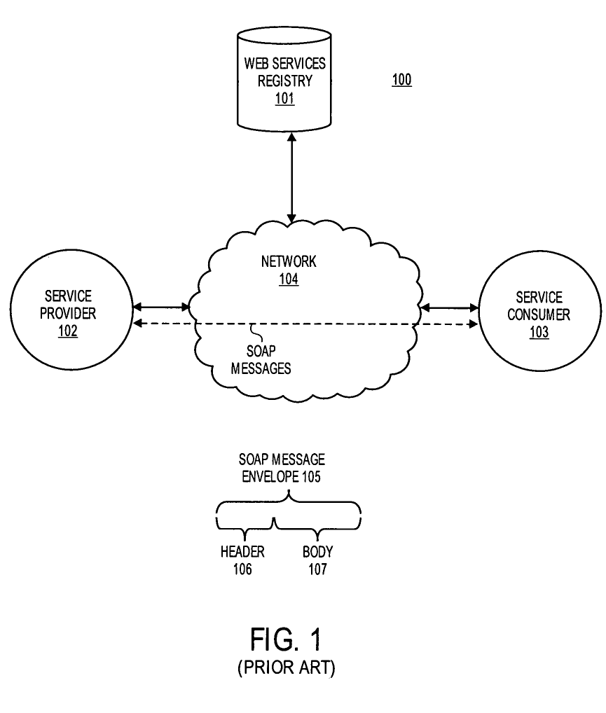

FIG. 2 illustrates an exemplary WSDL file (prior art);

FIG. 3 illustrates an embodiment of a system for generating a WSDL document from templates and configuration data;

FIG. 4 illustrates an embodiment of the flow of dynamically creating a WSDL document;

FIG. 5 illustrates the reference principles of templates applied in the creation of a WSDL document according to an embodiment;

FIG. 6A illustrates an embodiment of the flow for generating WSDL policies;

FIG. 6B illustrates an embodiment of the flow for the conversion of metadata to assertion elements;

FIG. 7 illustrates an embodiment of the flow for generating a configuration file from a policy annotated WSDL;

FIG. 8 illustrates the inheritance properties of marshallers according to one embodiment; and

FIG. 9 is a block diagram of a computing system that can execute program code stored by an article of manufacture.

### DETAILED DESCRIPTION

Described below is a system and method for dynamically generating a WSDL document. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

One embodiment of the invention generates a WSDL document from the abstract and concrete data stored in a configuration file as applied to templates for binding and port type.

### Dynamic WSDL Generation

In Web services systems, a WSDL file provides the outside world with the requirements for communicating with and utilizing the services of a service provider. As described earlier, these WSDL files are usually generated after a complete Web service has been defined by a provider and are likely to be an afterthought to the complex design process used to create a Web service. Dynamic creation and/or changing of WSDL documents allows for a Web service provider to describe new services or remove services easier. In one embodiment, as the WSDL document is updated or created without human intervention to create the WSDL document. For example, as soon as a new service is provided the WSDL document for the Web service provider is updated to reflect this change without having to manually create the new WSDL document.

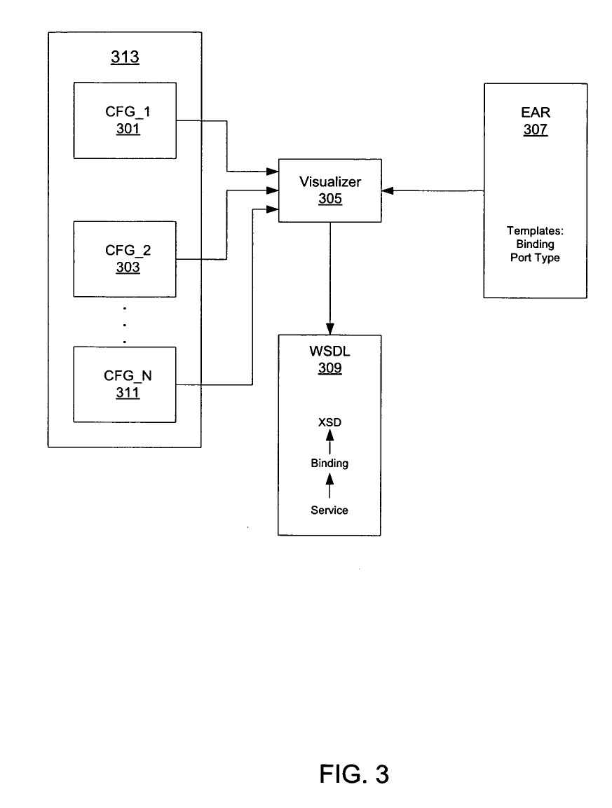

FIG. 3 illustrates an embodiment of a system for generating a WSDL document from templates and configuration data. These templates and configuration data were not available in the prior art. In an embodiment, a web services archive file contains WSDL templates and configuration file(s). These templates are generated during web service design time and are packaged inside the archive. This approach allows for dynamical edition/remove/add of a web service configuration. When a request for WSDL visualization is received, a WSDL file, is generated dynamically using the WSDL template and configuration data. Each template stores information regarding the structure and syntax of a portion of a WSDL document. For example, the binding template contains information relating to the protocol configurations of the service.

Upon a request (HTTP, HTTPS, FTP, etc.), a visualizer 305 uses at least one configuration file 313 which may contain multiple configuration components 301, 303, 311 and a template (binding, port type, etc.) stored in an archive 307 to create at least a portion of a WSDL document (for example, the port type, service, or binding section of the WSDL). In one embodiment, the template is stored in an EAR (Enterprise Archive) file. For example, an HTTP request made to the visualizer 305 causes the visualizer 305 to apply the relevant metadata configuration components 301, 303, 311 available to the port type template of the EAR 307 to create a service for the WSDL 309. Likewise a binding request to the visualizer 305 creates a WSDL binding reference for the WSDL 309. This technique may be applied to existing Web services by maintaining (or creating) configuration components or files in addition to the maintaining the EAR file(s) that is already deployed. In one embodiment, there is a template for every portion of the WSDL document. For example, there is a template for types, messages, port types, bindings, and services.

Each configuration 301, 311, 303 stores WSDL metadata about a service provided by the Web service provider. In an embodiment, configuration components of a configuration file are also specific to a particular policy domain such as security, reliable messaging, etc. For example, configuration component CFG_1 301 contains metadata regarding the security protocol that is to be used by the Web service for a particular service. The policy domain for security may include the type of encryption used and/or the type of signature required. A client that has retrieved the WSDL file that was created using this configuration file will be able to ascertain the security protocol is being utilized by the provider and how to properly construct messages from the client to the provider using this protocol. Other configuration components 303, 311 contain other metadata about a service provided. For example, CFG_2 311 contains session data and CFG_N 303 contains security and reliable messaging data about a service. Configuration components may be dynamically added, removed, or modified depending upon the services that are to be provided by the Web service.

There are two types of data available in most WSDL implementations: abstract and concrete data. Abstract data is design time configuration data and is associated with a port type, type, and/or message. Runtime configuration data (concrete data) is associated with a binding, service, and/or port. In one embodiment, each configuration is associated with only a single port. The use of configuration files allows for the separation of abstract and concrete WSDL data which was not possible in prior art systems. This separation allows for the dynamic creation and/or changing of a WSDL document. A WSDL document could be separated into abstract (porttype) and concrete (binding) parts. The configuration data from the configuration file(s) is additional metadata which again could be separated to abstract and concrete. This configuration metadata represents additional information, which cannot be described by the standard WSDL elements (types, messages, porttypes, bindings, services, ports) such as specific kinds of securities (signature, encryption), quality of service for message delivery (exactly one, exactly one in order, etc.), etc. An example of abstract configuration data is “I want encryption” with the concrete configuration data being “the encryption will be DES.”

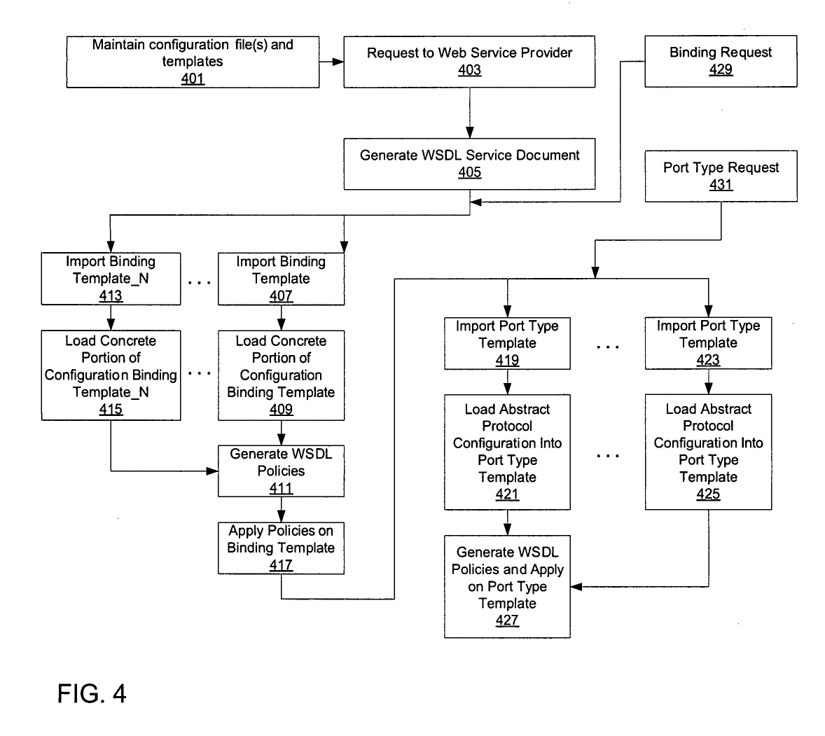

FIG. 4 depicts an embodiment of the flow of dynamically creating (visualizing) a WSDL document. Of course it should be understood that the WSDL document may already exist and is modified accordingly. Template and configuration files and/or components for a Web service are maintained at 401. Throughout the life of the Web service these files are updated, including being added, removed, or modified, to reflect the current requirements for accessing and using the service.

A service request to the Web service provider from a client is made at 403. In an embodiment, exemplary requests include HTTP requests, HTTPS requests, binding requests, etc.

The service portion of the WSDL document is generated at 405 if a service request has been made by the client connecting to the provider. During the generation of a service document, a service data is obtained from a service data registry of the provider. This data includes the correct binding and port names are gathered from a based on the URI provided by the client. For example, the visualizer 305 of FIG. 3 obtains binding and port names from the templates of the EAR 307.

A binding request is made from the client to the provider for a specific port at 409. This binding request initiates the importing of a stored binding template at 407, 413. As illustrated in FIG. 4, several ports may have their relevant binding template imported. In this example, Binding Template_1 is associated with port 1 and Binding Template_N is associate with the Nth port of the provider's service. Accordingly, a binding request for port 1 initiates the importing of Binding Template_1.

With the appropriate binding template imported, the concrete portion of the configuration file associated with that binding template is loaded at 409, 415. For example, the protocol(s) definitions described in a configuration file associated with Binding Template_1 are imported into the WSDL service document.

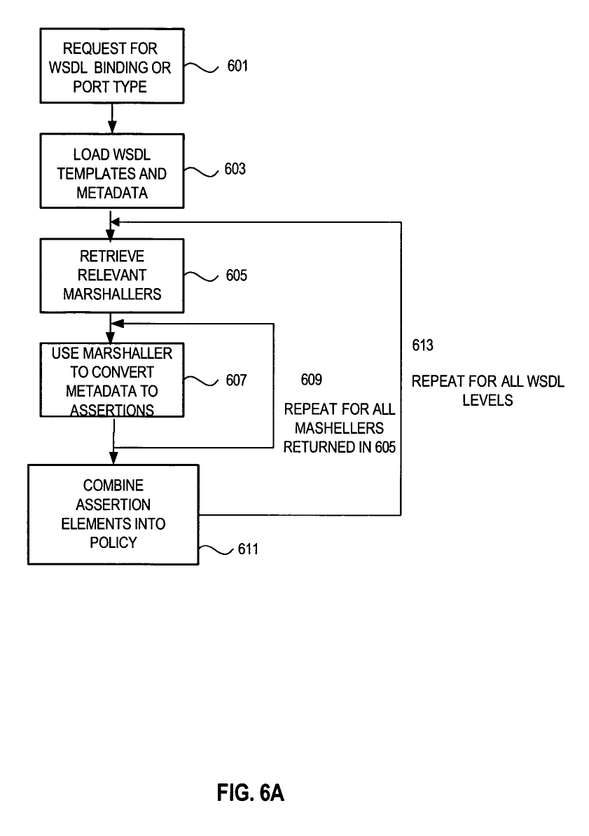

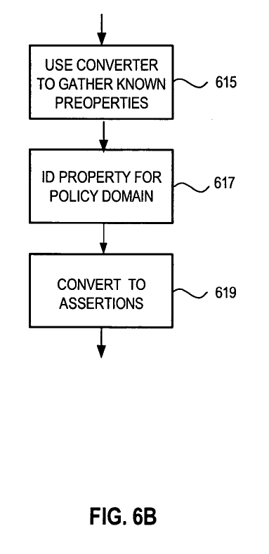

WSDL policies are generated using the concrete data loaded at 411. An embodiment of this generation will be described in detail later in FIGS. 6A and 6B. WSDL policies may be Web service specific (for example, a policy may be a feature of a particular Web service implementation such as those deployed by IBM, SAP, Microsoft, etc.) or generic (for example, a policy may apply to a Web service specification like WS-Security or WS-ReliableMessaging). For ease of understanding, the term policy or policies encompasses both policy types unless otherwise noted.

These generated WSDL policies are then applied to the binding template at 417 to create the binding elements of the WSDL file.

A request for port type initiates the importing of a port type template at 431. Like binding, several port type templates may be imported 419, 423 based on the particular request.

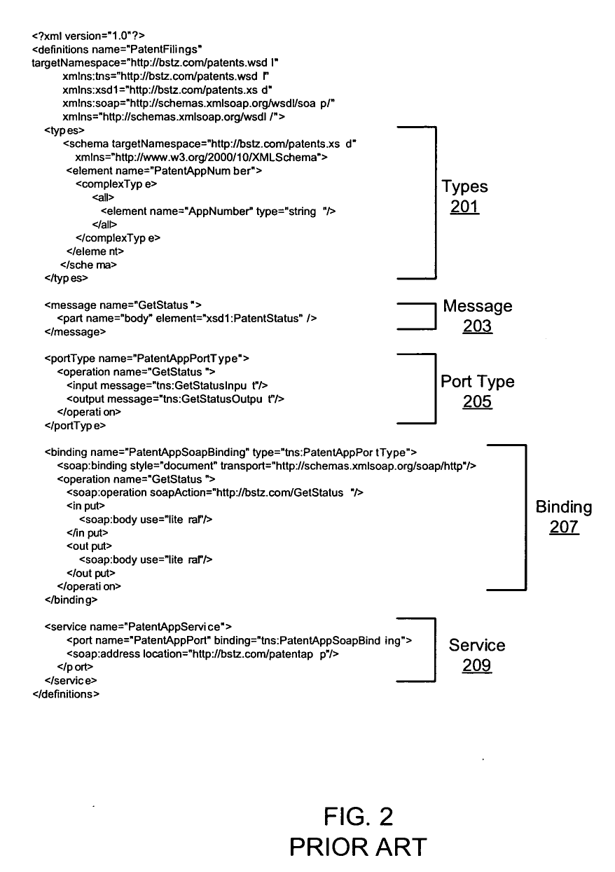

The abstract portion of the relevant configuration file is loaded at 421, 425 into a port type template. The abstract portion describes the set of operations supported by the port. For example, in FIG. 2 the “GetStatus” operation is supported by the bstz.com Web service.

WSDL policies are generated by applying these abstract portions on the port type template at 427 to create the port type portion of the WSDL file. In one embodiment, this generation is done in a manner similar to that of WSDL policy generation for binding at 411. An embodiment of this generation will be described in detail later in FIGS. 6A and 6B.

A WSDL document is created or modified when the port types, bindings, and services have been created and/or modified. The service document imports one or more binding WSDL documents. By reading the import data from service WSDL document the WS consumer “understands” on what URL to request the binding WSDL document(s). Each binding WSDL document imports only one port type WSDL document. By reading the import data from the binding WSDL document the WS consumer “understands” on what URL to request the port type WSDL document. Thus, a complete WSDL document consists of at least three separate WSDL files which are downloaded from different URLs and which relate to one another via WSDL import elements as described below.

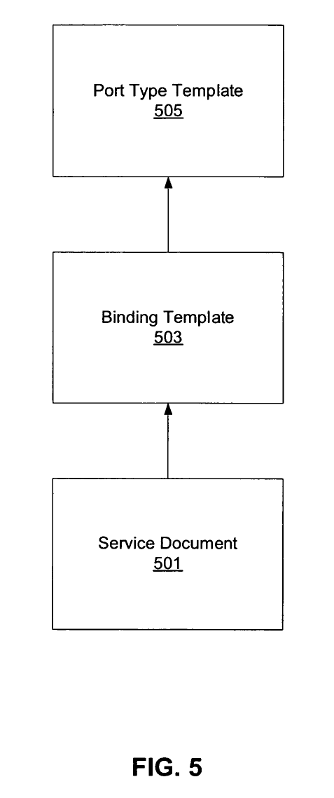

FIG. 5 illustrates the import principles of templates applied in the creation of a WSDL document according to an embodiment. At least three documents and/or templates are used to create a WSDL file. A service document 501 is generated upon request. The service document describes services and their ports and addresses.

Binding templates 503 describe protocol configurations used in a Web service implementation. The binding template(s) 503 imports a port type WSDL document. The port type 505 template imports nothing.

Of course it should be understood that requests for service, binding, or port type may come in any order.

### Server Side Policy Generation

Policy domains are sets of assertions for a particular protocol. Each assertion is an XML element defined by a particular Web services specification (for example, WS-Security, WS-ReliableMessaging, etc.) having some specific semantic and syntax. For example, in the security policy domain the assertions are the types of encryption or signatures used by the particular Web services provider. Configuration file information is converted into policies (non-implementation specific) or features (implementation specific) during the creation of WSDL documents.

FIG. 6A illustrates an embodiment of the flow for generating WSDL policies. A request for a WSDL binding or port type component is made to a visualizer at 601. The relevant WSDL template associated with the request is loaded along with metadata from at least one configuration file at 603 (ror example, configurations of a configuration file is loaded with the request).

The set of relevant marshallers (converters) needed to process a configuration file is retrieved from a registry (marshaller factory) or other storage location on the Web services provider at 605. Each marshaller provides functionality to convert configuration file properties into assertion elements. There is at least one marshaller per each policy domain.

A marshaller from the set is used to convert configuration metadata into assertion elements at 607. An embodiment of this conversion is described in greater detail in FIG. 6B.

Each converter from the set performs the conversion of 607 at 609. In other words, the conversion process should be repeated for each policy domain. The results of all of the conversions, assertion elements, are combined to form a policy element at 611. This policy element is applied to the WSDL template loaded at 603 to create the WSDL component requested at 601.

This conversion from metadata to a policy element may be repeated at 613 for the other WSDL levels until a complete policy annotated WSDL is formed. For example, if the request at 601 was for a port type, the conversion may be repeated for binding. Of course, it should be understood that if the policy annotated WSDL is being updated for a particular component (binding, port type, etc.) then the other components may not need to be updated and the conversion from metadata to policy element does not need to occur.

FIG. 6B illustrates an embodiment of the flow for the conversion of metadata to assertion elements. Each marshaller is aware of a few properties that a particular policy domain supports. In other words, each marshaller may only process properties that it supports. The names of these known properties for a specific policy domain are gathered by a marshaller from the configuration file that the marshaller is associated with at 615.

These property names are compared to the configuration metadata to identify which properties are stored in the metadata and therefore convertible by the marshaller at 617. In other words, the marshaller not only has the capability to process a particular metadata but the configuration file contains the metadata. In one embodiment, this comparison is done by a so-called configuration builder. This builder is also responsible for gathering the marshallers from the registry.

The identified metadata is then converted into assertion elements by the marshaller at 619. This process of retrieving property names that the marshaller supports the conversion of, identifying the metadata that is available to be converted by this particular marshaller, and converting this metadata into assertion elements is repeatable for each marshaller from the set of marshallers of the marshaller factory.

In one embodiment, there is a single generic marshaller to perform operations on every type policy domain. Therefore, certain tasks described above may be eliminated. For example, the comparison at 617 may be eliminated.

### Client Side Configuration Creation

As described earlier, clients retrieve WSDL documents from Web service providers. These WSDL documents need to be “converted” into an understandable form (WS metadata) for the client. A part of this conversion is to create metadata property names from assertions in the XML (WSDL) document.

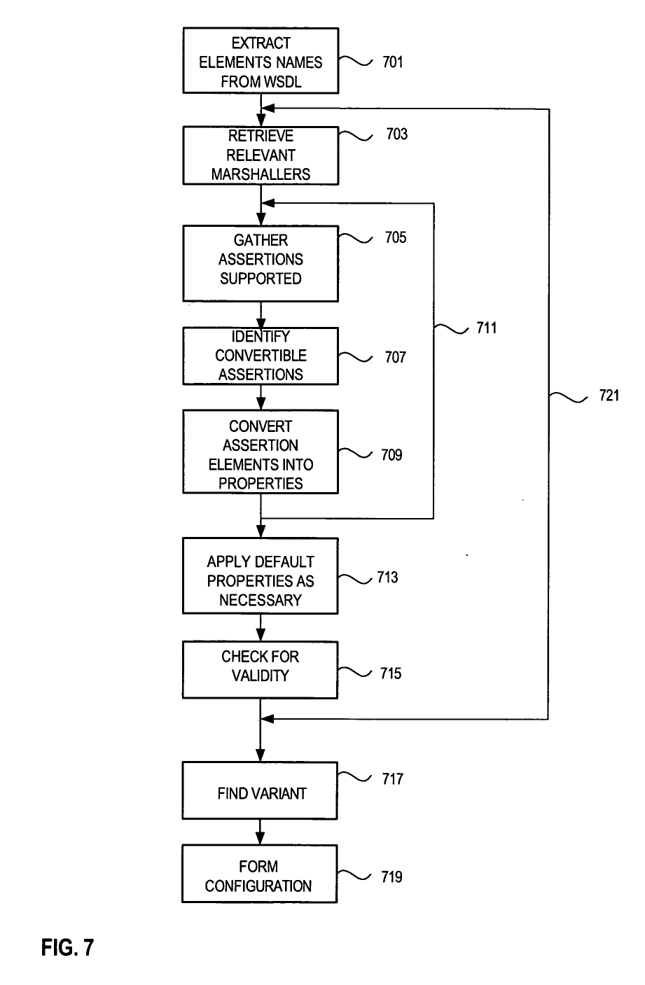

FIG. 7 illustrates an embodiment of the flow for generating a configuration from a policy annotated WSDL. From one WSDL, a configuration file is generated, which file could contain several configurations, depending how many endpoints (ports) the WSDL has. Assertion element names for a specific WSDL level (for example, port type, binding, etc.) are gathered from the policy annotated WSDL at 701. Each marshaller provides functionality to convert WSDL assertions into metadata properties. In one embodiment, there is one marshaller per each assertion. Each marshaller is aware of a few properties that a particular assertion supports. In other words, each marshaller may only process assertions that it supports.

Using these assertion element names, the associated marshallers are retrieved from a registry or other storage location of the client, such as a marshaller factory, at 703. For a particular marshaller retrieved at 703, the marshaller gathers the set of assertions that the marshaller supports at 705. In other words, this set identifies which assertions the marshaller is able to process into metadata properties.

These assertion element names are compared to the WSDL to identify which assertions are in the WSDL and are therefore convertible by the marshaller at 707. In other words, the marshaller not only has the capability to process a particular assertion but the WSDL contains the assertion. In one embodiment, this comparison is done by a so-called configuration builder. This builder is also responsible for gathering the marshallers from the registry.

The marshaller used at 703 converts the assertion elements of the WSDL into metadata properties at 709. Each marshaller from the set performs the conversion of 709 at 711. The results of all of the conversions, metadata properties, are combined to form a property list. Because there are properties for which no match could be found at 707, default properties of the marshaller are applied to the property list at 713.

It is possible that two or more properties cannot be combined into the same metadata. In other words, the property list may have conflicting entries. For example, the property list may show that the for security purposes a signature is required but later in the list shows that a signature is not required. For this reason, the updated property list is checked for validity at 715 and any problems are reported to the client. If there are problems, the processing is stopped and requires further investigation to determine the proper course of action. For example, the property list may need to be manually adjusted. Each WSDL level should perform the above operations at 721.

The marshaller checks for abstract properties that correspond to a specific concrete property and returns a list of possible abstract configurations (variants) at 717. This relates a specific concrete portion of the WSDL to a specific abstract property. For example, specific type of encryption is a concrete portion of the WSDL and this relates to the abstract configuration of overall security.

Abstract configuration alternatives may exist as different marshallers may return valid configuration alternatives. Because of this the configuration alternatives are intersected to form a single abstract configuration that applies to the complete WSDL at 719. For example, a security marshaller may return configurations for two different types of RSA encryption (HTTP and SSL). A reliable messaging marshaller may only have one type of RSA encryption (HTTP). While each of these alternatives provided by each respective marshaller is valid, only one configuration alternative is common to all marshallers, RSA HTTP.

In one embodiment, there is a single generic marshaller to perform operations on every type of assertion. Therefore, certain tasks described above may be eliminated. For example, the creation of the assertion array at 707 may be eliminated with a single generic marshaller.

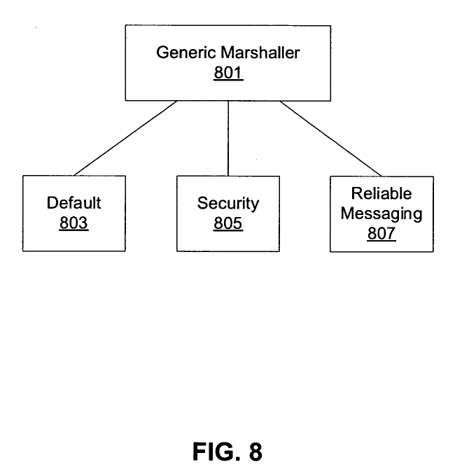

In one embodiment, marshallers on both the client and provider side have the same basic functionality that stems from a generic parent marshaller. FIG. 8 illustrates the inheritance properties of marshallers according to one embodiment. The generic marshaller 801 provides functions for: 1) getting the known assertion names from a WSDL; 2) getting known property names from a configuration file; 3) converting assertions into metadata; 4) converting metadata into assertions; 5) applying default properties to a listing of properties; 3) finding variants; and 7) checking a configuration file for errors. Additional functionality may be added to the generic marshaller as the Web services provider adds functionality.

This generic marshaller serves as the model for a default configuration marshaller 803 (this marshaller applies the default properties to a listing of properties), a security marshaller 805 (this marshaller knows the security rules such as encryption and/or signature type), and a reliable messaging marshaller 807 (this marshaller knows the rules associated with reliable messaging). Each of these marshallers may inherit all of or a subset of the functions provided by the generic marshaller 801. Additional marshallers may be added as functionality is added with the Web service.

The use of common marshallers allows for easier deployment of Web services as separate marshallers do not have to be developed for the client and provider side. As the marshallers have common functionality (commands) it is also easier to program because there are no difference between commands used by each marshaller. For example, the convert metadata into assertions command of the security marshaller 805 is the same as the reliable messaging marshaller 807.

Processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., .NET, Mono, Java, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.).

According to various approaches the abstract execution environment may convert the intermediate form program code into processor specific code by, 1) compiling the intermediate form program code (e.g., at run-time (e.g., a JIT compiler)), 2) interpreting the intermediate form program code, or 3) a combination of compiling the intermediate form program code at run-time and interpreting the intermediate form program code. Abstract execution environments may run on various operating systems (such as UNIX, LINUX, Microsoft operating systems including the Windows family, Apple Computers operating systems including MacOS X, Sun/Solaris, OS/2, Novell, etc.).

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

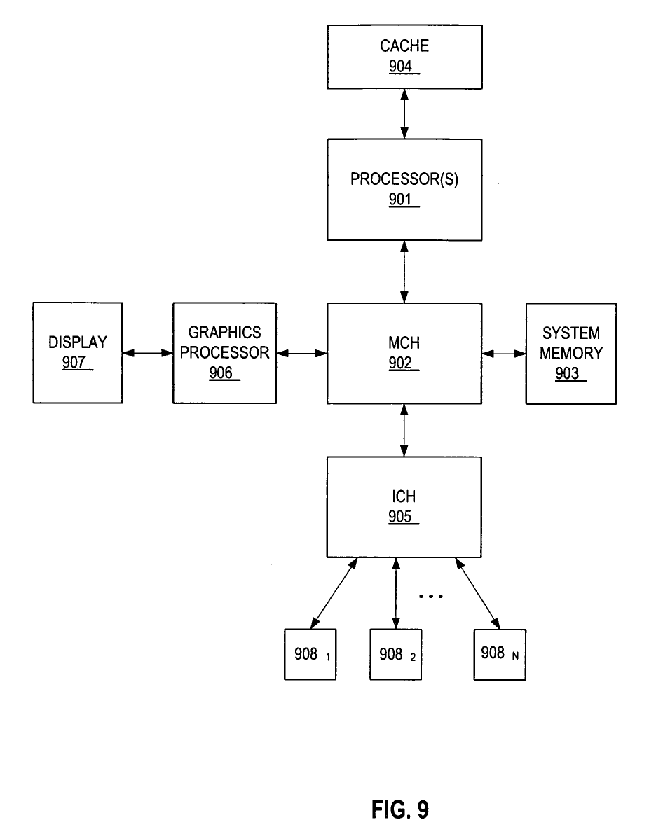

FIG. 9 shows an embodiment of a computing system (e.g., a computer). The exemplary computing system of FIG. 9 includes: 1) one or more processors 901; 2) a memory control hub (MCH) 902; 3) a system memory 903 (of which different types exist such as DDR RAM, EDO RAM, etc,); 4) a cache 904; 5) an I/O control hub (ICH) 905; 6) a graphics processor 906; 7) a display/screen 907 (of which different types exist such as Cathode Ray Tube (CRT), Thin Film Transistor (TFT), Liquid Crystal Display (LCD), DPL, etc.; 8) one or more I/O devices 908.

The one or more processors 901 execute instructions in order to perform whatever software routines the computing system implements. The instructions frequently involve some sort of operation performed upon data. Both data and instructions are stored in system memory 903 and cache 904. Cache 904 is typically designed to have shorter latency times than system memory 903. For example, cache 904 might be integrated onto the same silicon chip(s) as the processor(s) and/or constructed with faster SRAM cells whilst system memory 903 might be constructed with slower DRAM cells. By tending to store more frequently used instructions and data in the cache 904 as opposed to the system memory 903, the overall performance efficiency of the computing system improves.

System memory 903 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 903 prior to their being operated upon by the one or more processor(s) 901 in the implementation of a software program. Similarly, data that a software program determines should be sent from the computing system to an outside entity through one of the computing system interfaces, or stored into an internal storage element, is often temporarily queued in system memory 903 prior to its being transmitted or stored.

The ICH 905 is responsible for ensuring that such data is properly passed between the system memory 903 and its appropriate corresponding computing system interface (and internal storage device if the computing system is so designed). The MCH 902 is responsible for managing the various contending requests for system memory 903 access amongst the processor(s) 901, interfaces and internal storage elements that may proximately arise in time with respect to one another.

One or more I/O devices 908 are also implemented in a typical computing system. I/O devices generally are responsible for transferring data to and/or from the computing system (e.g., a networking adapter); or, for large scale non-volatile storage within the computing system (e.g., hard disk drive). ICH 905 has bi-directional point-to-point links between itself and the observed I/O devices 908.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method comprising:
extracting assertion elements from particular level of a Web services description file;
converting the assertion elements into properties; and
forming a configuration file from the properties.

2. The method of claim 1, further comprising:
accessing a marshaller relevant to the particular level of the Web services description file, the marshaller to perform the converting.

3. The method of claim 2, wherein the converting further comprises:
determining a set of assertions supported by the marshaller;
identifying related assertions in the Web services description file; and
converting the related assertions into properties;
combining the properties into a property list.

4. The method of claim 3, further comprising:
applying default properties to the property list; and
updating the property list.

5. The method of claim 4, further comprising:
determining if the property list is valid.

6. The method of claim 5, further comprising:
determining possible configurations alternatives from the Web services description file; and
intersecting the abstract configuration alternatives to form a single abstract configuration.

7. The method of claim 1, wherein the Web services description file is a WSDL document.

8. An article of manufacture including program code which, when executed by a machine, causes the machine to perform a method, the method comprising: extracting assertion elements from particular level of a Web services description file;
converting the assertion elements into properties; and forming a configuration file from the properties.

9. The article of manufacture of claim 8 wherein said executing further includes also performing the following:
accessing a marshaller relevant to the particular level of the Web services description file, the marshaller to perform the converting.

10. The article of manufacture of claim 9, wherein the converting further comprises:
determining a set of assertions supported by the marshaller;
identifying related assertions in the Web services description file;
converting the related assertions into properties; and
combining the properties into a property list.

11. The article of manufacture of claim 10 wherein said executing further includes also performing the following:
applying default properties to the property list; and
updating the property list.

12. The article of manufacture of claim 11 wherein said executing further includes also performing the following:
determining if the property list is valid.

13. The article of manufacture of claim 12 wherein said executing further includes also performing the following:
determining possible configurations alternatives from the Web services description file; and
intersecting the abstract configuration alternatives to form a single abstract configuration.

14. The article of manufacture of claim 8, wherein the Web services description file is a WSDL document.

15. A computing system comprising a machine, said computing system also comprising instructions disposed on a computer readable medium, said instructions capable of being executed by said machine to perform a method, said method comprising:
extracting assertion elements from particular level of a Web services description file;
converting the assertion elements into properties; and
forming a configuration file from the properties.

16. The computing system of claim 15, wherein said method further comprises:
accessing a marshaller relevant to the particular level of the Web services
description file, the marshaller to perform the converting.

17. The computing system of claim 16, wherein the converting further comprises:
determining a set of assertions supported by the marshaller;
identifying related assertions in the Web services description file;
converting the related assertions into properties; and
combining the properties into a property list.

18. The method of claim 3, further comprising:
applying default properties to the property list; and
updating the property list.

19. The computing system of claim 17, wherein said method further comprises:
determining if the property list is valid.

20. The computing system of claim 19, wherein said method further comprises:
determining possible configurations alternatives from the Web services description file; and
intersecting the abstract configuration alternatives to form a single abstract configuration.
